(19) United States
(12) Patent Application Publication
(10) Pub. No.: US 2015/0046407 A1
(43) Pub. Date: Feb. 12, 2015

(54) Systems and Methods for Preserving Content in Digital Files

(71) Applicant: Paramount Pictures Corporation, Los Angeles, CA (US)

(72) Inventors: Andrea KALAS, Los Angeles, CA (US); Sean VILBERT, Los Angeles, CA (US); Erika McPHERSON, Los Angeles, CA (US); Vitaliy VAYSBERG, Los Angeles, CA (US)

(73) Assignee: Paramount Pictures Corporation, Los Angeles, CA (US)

(21) Appl. No.: 13/963,785

(22) Filed: Aug. 9, 2013

(51) Int. Cl. G06F 17/30

(52) U.S. Cl. CPC G06F 17/30371
USPC 707/691

(57) ABSTRACT

Described are systems and methods for preserving digital assets, which assets comprise one or more files. The system and methods prepare a digital file for ingest into an asset management system, store a plurality of copies of the digital file based on a set of storage policies for the digital file, and perform a health check on each copy of the digital file. The system and method may include performing an asset repair on the copies of the digital file that failed the health check as well as the exporting of a digital file.

### BACKGROUND

Digital cinematography is the process of capturing motion pictures as digital images, as opposed to the historical use of motion picture film. Digital capture may occur on video tape, hard disks, flash memory, or any other media which can record digital data through the use of digital movie cameras or video cameras. As digital technology has improved, this practice has become increasingly common. Many mainstream Hollywood movies now are shot partly or fully digitally.

When movies were shot on analog photochemically created and processed film stocks, the preservation of those movies was tied to the analog nature of film production. In the analog world, the original content representing a final feature film was an original film negative. It represented the highest quality of the film itself, because it was cut from camera stock that had been used in the camera. As such, the preservation of the film (for example, Raiders of the Lost Ark) was intrinsically tied to the preservation of media (example Kodak Eastmancolor 5247 100T camera negative film stock in the final cut camera negative). Once stored in ideal environments, the original film negative can last potentially hundreds of years.

File based original content, which includes films, television shows, recorded sound, publications, etc., faces the same threats and risks as all data faces: loss or corruption due to damage, degradation of media, disaster, information system errors, obsolete removable media, proprietary storage methods for “archiving” data off of servers, inaccurate indexing and a host of other natural threats to data. Original content from feature films has the added complexity of having very large files and large sets of files. The preservation management of these sets of files cannot accurately or effectively be done with methods that worked in the analog world. For example, migration of large sets of data from one removable media to another at regular intervals essentially treats the original content as if it were still analog (i.e., assuming that it will be fine if left alone). This migration is inadequate since there is no way (as there was with film stocks) to anticipate the exact time when some sort of error or loss might occur. Similar to footage that is shot on traditional film, it is important to the owner of the digital film (e.g., a motion picture studio) to preserve the digital film completely intact so that it may be used and distributed for many years. Similarly, other forms of creative endeavor, such as music recording, magazine publishing and television production, are reliant nearly exclusively on digital technology and face the same challenge for ensuring the ongoing preservation and use of file-based assets.

### DESCRIPTION OF THE DRAWINGS

FIG. 1 shows an exemplary preservation system for asset preservation and digital archiving according to the exemplary embodiments described herein.

FIG. 2 shows an exemplary method for asset preservation and digital archiving according to the exemplary embodiments described herein.

FIG. 3 shows an exemplary method for preparing an asset for ingest according to the exemplary embodiments described herein.

FIG. 4 shows an exemplary method for metadata validation according to the exemplary embodiments described herein.

FIG. 5 shows an exemplary method for technical validation according to the exemplary embodiments described herein.

FIG. 6 shows an exemplary method for ingest by the preservation component according to the exemplary embodiments described herein.

FIG. 7 shows an exemplary method for performing a health check on a material according to the exemplary embodiments described herein.

FIG. 8 shows an exemplary method for exporting material according to the exemplary embodiments described herein.

FIG. 9 shows an exemplary method for repairing an asset according to the exemplary embodiments described herein.

FIG. 10 shows an exemplary code table of the preservation component according to the exemplary embodiments described herein.

FIG. 11 shows an exemplary health check dashboard of the health check component according to the exemplary embodiments described herein.

FIG. 12 shows an example folder structure for an original camera file.

### DETAILED DESCRIPTION

Described herein are systems and methods for media asset preservation. A method may include preparing a digital file for ingest into an asset management system, storing a plurality of copies of the digital file based on a set of storage policies for the digital file, performing a health check on each copy of the digital file and performing an asset repair on each copy of the digital file that failed the health check.

Further described herein is a system having components that are implemented by a processor. The components include an ingest component to prepare a digital file for ingest into an asset management system, a storage policy component to indicate a storage policy for the digital file, a storage interface to store a plurality of copies of the digital file based on the storage policy for the digital file and a health and repair component to perform a health check on each copy and perform an asset repair on each copy that failed the health check.

Further described herein is system including a processor and a non-transitory computer readable storage medium including a set of instructions that when executed by the processor, cause the processor to perform operations. The operations include preparing a digital file for ingest into an asset management system, storing a plurality of copies of the digital file based on a set of storage policies for the digital file, performing a health check on each copy of the digital file, and performing an asset repair on each copy of the digital file that failed the health check.

The exemplary embodiments may be further understood with reference to the following description and the appended drawings, wherein like components are referred to with the same reference numerals. The exemplary embodiments show systems and methods for preserving and archiving assets. For instance, systems and methods described herein may relate to storage and quality evaluation of complex assets, such as digital motion pictures. The exemplary embodiments may allow for replication of the media asset (e.g., for disaster recovery), monitoring and repairing any corrupt assets (e.g., “health checks”), and securing the assets against loss and/or theft.

While the exemplary embodiments described herein and described with reference to the preservation and archiving of digital motion pictures, one skilled in the art will understand that the exemplary systems and methods described herein may be applied to any type of digital media assets (e.g., television productions, photographs, music, etc.).

Traditionally, digital preservation materials are stored on removable media and the media is barcoded and managed as physical inventory. The replication, or cloning, and validation of the media are performed upon request by vendors. While the conventional processes for managing digital materials may help to prevent asset loss, these processes do not contemplate any assessment of the quality of the assets to be preserved (i.e., cloning a bad file “perfectly” merely creates another copy of the bad file), nor do they allow for automated evaluation of asset quality through health checks. Furthermore, conventional processes do not protect materials via managed replication or geographic separation. Furthermore, these replication processes only support single-file assets. Specifically, any metadata associated with conventional preservation processes is limited to information related to preservation title, title-version, material and technical attributes.

The following goals apply to the preservation of file based assets: (i) preserve correct authenticated original content; (ii) protect original content from loss; (iii) keep original content in its highest possible quality; (iv) protect original content from natural and man-made disasters; (v) demonstrate the preservation of original content; (vi) keep original content secure from theft, and accidental misplacement; (vii) efficiently perform the preservation activity without compromising protection from loss; and (viii) directly support future use of the preserved asset.

To achieve these goals for file-based media, an approach that is contrary to traditional preservation is undertaken. While archivists have traditionally worked to preserve the original materials on which the original content resides, there is no concept of an original in a file-based world. The very nature of file based assets is that they are surrounded by the potential for obsolescence through changing software and advancement of removable media such as data tapes and hardware components that connect hard drives to CPUs, etc. For this reason each asset, by its very nature, must keep their integrity independent of the fixed storage media in which the asset resides. Each individual file that makes up a single or complex asset is authenticated, replicated and checked for viability. A manner of achieving this is through the systems and managed storage platforms defined below.

Ingest ensures authentication of each file through automated metadata association that ties the highest-level description of the asset (its legal authoritative title and version, for example) all the way through to its most granular technical level. When ingesting complex assets, this process can include the automated assignment and calculation of the metadata for each file that makes up the complex asset. Further, the automated ingest validates the unique identity of each file upon being committed to the system. These are all steps that authenticate and validate that the asset that is being preserved is in fact, and in every way that very asset.

Replication automatically applies preservation level storage policy. Since file-based assets can be replicated without quality loss and since all potential risks to data systems cannot be quantitatively anticipated, multiple copies of file-based assets prevent the loss of original content. Storage polices further ensure the placement of those files in geographically distinct areas, further reducing the risk of loss due to a natural or man-made disaster in one location.

Health checks and the reporting of health check results verify that the original content has not suffered loss by showing that if a replicate has suffered corruption, bit rot or any other issue, it has been repaired by replacing a bad replicate with a healthy one. Tracking and demonstrating this function in an easily understood manner is an aspect of preservation proof.

Security of original content by managing workflows for use is a way of ensuring that the authenticated original content is not misused, lost or given to unauthorized users. Exporting functionality allows access to the files for authorized users and enables the use of automated processes that are capable of supporting future developed distribution models.

In order to protect the original content in an efficient manner, these processes should be automated to the extent possible. Without automation, some processes may become unsustainable and inaccurate, each of which may pose a risk of loss to file based assets. This automation includes the interface between a media asset management system and a storage facility, such as a hierarchal storage management system.

As will be described in greater detail below, the exemplary embodiments may support single or complex assets, which are materials that contain more than one file, for automated preservation. In addition to the metadata discussed above, the multi-part file materials may include file, replicate, and health check information. Workflows may be streamlined and automated by integrating business rules, ingest and approvals within the embodiments. For instance, health checks performed by the exemplary systems and methods may detect data corruption and provide automated remediation of that corruption. Although the exemplary embodiments described below relate to theatrical digital files, the methods and systems are useful for any kind of digital files, including complex assets or groups of related digital files unrelated to motion picture files.

The exemplary complex assets discussed above may include final theatrical digital intermediate (“DI”) files created during the finishing process of a motion picture. DI files are the final rendered frames of a film. The process of creating a DI file involves digitizing the motion picture and manipulating the color and other image characteristics. Each of the DI files may represent a single frame of film (e.g., having a file size of 6-50 MBs each) having a file format, such as uncompressed digital picture exchange (.dpx), tagged image file format (“TIFF”) (.tif), Cineon file format (.cin), etc. For instance, an average title may have 7 reels, wherein each reel includes an average frame count of 20,000 frames. Accordingly, the average memory size for such a title may be in the range of 2-8 TBs.

Additional complex assets may include preservation raw scan files, digital cinema package (“DCP”) files, final theatrical audio full mix, final theatrical audio stems, and original camera files (“OCFs”). Preservation raw files are the highest quality scan of the most original element of a preservation title. A DCP file may be described as a collection of digital files used in digital cinema production. The complete final domestic theatrical DCP file may be retained to preserve the final released version of a film. These files may also include supplemental audio-only packages representing alternate audio configurations. The audio full mix files are the final audio mix down of the finished feature film, wherein each file may represent a single audio channel. Audio stem files are the separate tracks (e.g., dialogue, music, effect) of a finished feature film. OCFs may be described as a bundle of files that have been captured by an imaging device (e.g., digital camera) for the production of a feature film.

The complex assets of the exemplary systems and methods described herein are not limited to the files listed above. In addition to files, a well-delivered title may contain related files, such as lined script files, codebook files, project files, etc. Accordingly, digital files of these renditions may be ingested and reside within the same content record as the OCF or other files.

One skilled in the art will understand that the term “ingest” describes the process of ensuring that a digital file is accurately described and has successfully moved into an asset management system. Furthermore, during ingest, additional information may be added to the file metadata record, such as program identifiers, time stamps, etc. The ingest process of the exemplary systems and methods will be described in greater detail below.

Complex assets may leverage existing metadata schemas by assigning common core attributes to the material-level metadata record. Additional data may include a field indicating “material group,” the creation of aggregate fields to calculate total file count and total file size (e.g., in MB) per complex asset.

Further additional file-level metadata may include detailed information specific to each file. File details may include, but are not limited to, file order, file ID, file name, MD5 checksum, file size, file path, ingest date/time, file status, etc. Although the MD5 checksum is an exemplary file detail, the systems and methods disclosed herein are not limited to the use of a MD5 checksum, but instead may be used with any kind or type of digital fingerprint or file attribute that provides an indication that the contents of the file have changed. The digital fingerprint or file attribute (including the MD5 checksum) may be referred to as a reliable digital fingerprint. The display of the file metadata may be adjusted based on user preferences such as a display range of file IDs (e.g., display File IDs 1 through 20). This display may be a sortable grid listing file details for the material as well as showing the total count of files in selected material.

The term “export” describes the process of making an identical copy of a digital file from an asset management system. The additional data about the material files allows for greater capabilities during material exportation. For instance, file metadata may be exported for a select range of files of a complex asset, as well as the ability to export the selected range files. File export transaction details may be recorded within the historical transaction log maintained for each copy of each file. For example, a user may want to review the first three minutes of a motion picture. This user may locate a material record for the first reel of the picture and explore the file metadata of the selected material. The user may then submit a start file ID, an end file ID, storage location, destination file name and destination file path (e.g., directory structure). This information may allow the user to export the files within that selected range and write the files to the specified library, path and nested within a directory structure supplied at ingest.

The complex assets may also feature various user-based security policies related to the maintenance of the material. By way of example, user accounts and groups may be created and assigned, as well as application permission roles for each of the users and/or groups. The permission roles may dictate the actions available to the user, such as viewing information related to the material, modifying attributes of the material, add/delete attachments to the material, etc. Permission roles may include administration roles for creating, modifying and viewing workflow templates. The security policies may also include approval for interacting with high-security materials and the ability to send notifications to a security group to approve/deny the movement or deletion of secured materials. Security policies may allow for automated content record security, such as the ability to create content record security templates within a code table and to automatically apply content record security templates during material ingest and content record creation. Further security policies may relate to the ability to view materials, display metadata or view lower-resolution proxy representations of the material.

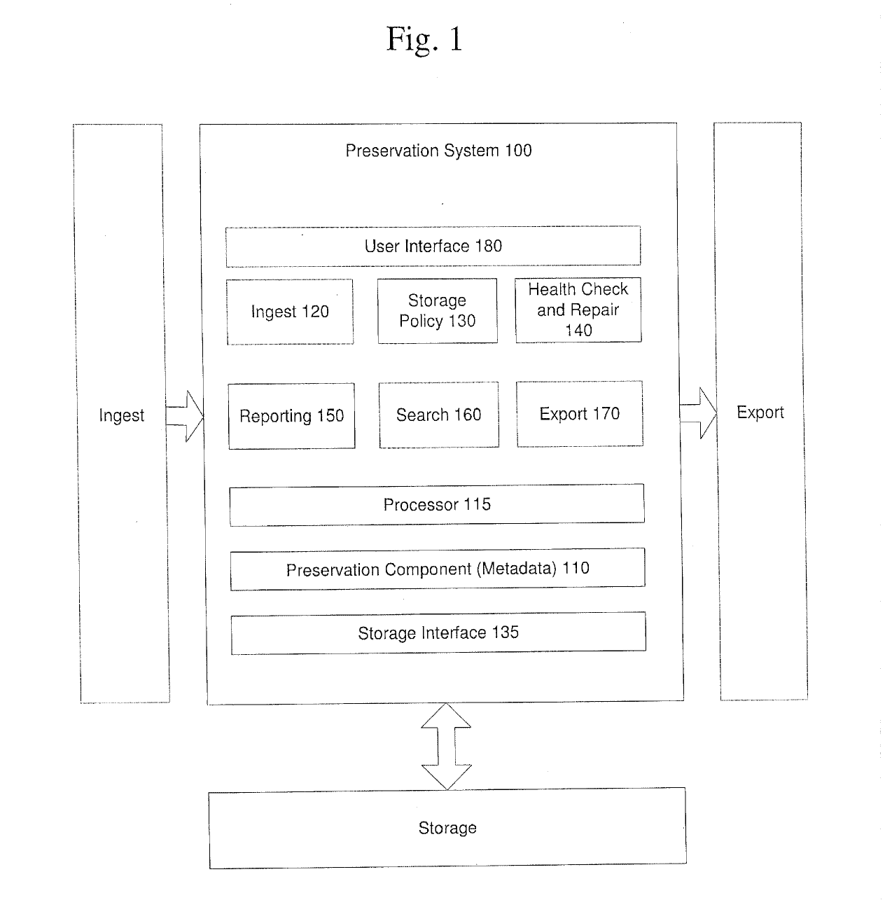

FIG. 1 shows an exemplary preservation system 100 for asset preservation and digital archiving according to the exemplary embodiments described herein. As depicted in FIG. 1, the preservation system 100 may include the functionality to ingest assets, store multiple copies of the assets and export assets as needed. The exemplary components used to accomplish these functionalities will be described in greater detail below.

The preservation system 100 may include a preservation component 110, a processor 115, an ingest component 120, a storage policy component 130, a storage interface 135, a health check and repair component 140, a reporting component 150, a searching component 160, an export component 170 and a user interface component 180. While each of the components illustrated in FIG. 1 are depicted as separate components, one skilled in the art will understand that any number or all of the components may be integrated with another. Furthermore, the processor 115 may direct the performance of each component. Alternatively, one or more of the components may include individual processors for directing their respective performances.

The exemplary ingest component 120 may support complex assets and implement an ingest toolset to centralize work streams to flow into a single system. The exemplary ingest component 120 may normalize one ingest ticket created per material, and automate both metadata validation and technical validation. There are several work streams that may be utilized to generate metadata for ingest of materials to the preservation component 110, such as a web form for a single asset, a grid form for multiple assets, etc.

Within the exemplary ingest component 120, asset staging may be used to generate an index file-of-contents of complex asset directory structures, wherein input may be a directory location and output may be a valid XML document describing file details (e.g., file path, file name, MD5 checksum, etc.). Furthermore, the ingest component 120 may facilitate the movement of massive amounts of files from an ingest workstation to the preservation component 110.

Further functions of the ingest component 120 allow for the user to enter metadata for assets (single-part asset or complex asset), reference/include an index file with MD5 checksums and files names to be used for complex assets, load metadata for multiple assets from a source file or spreadsheet, copy/paste metadata from a source file, retrieve metadata from an order management system, enter notations, etc. In addition, the user may indicate any fields that are required or optional by rendition of the preservation component 110.

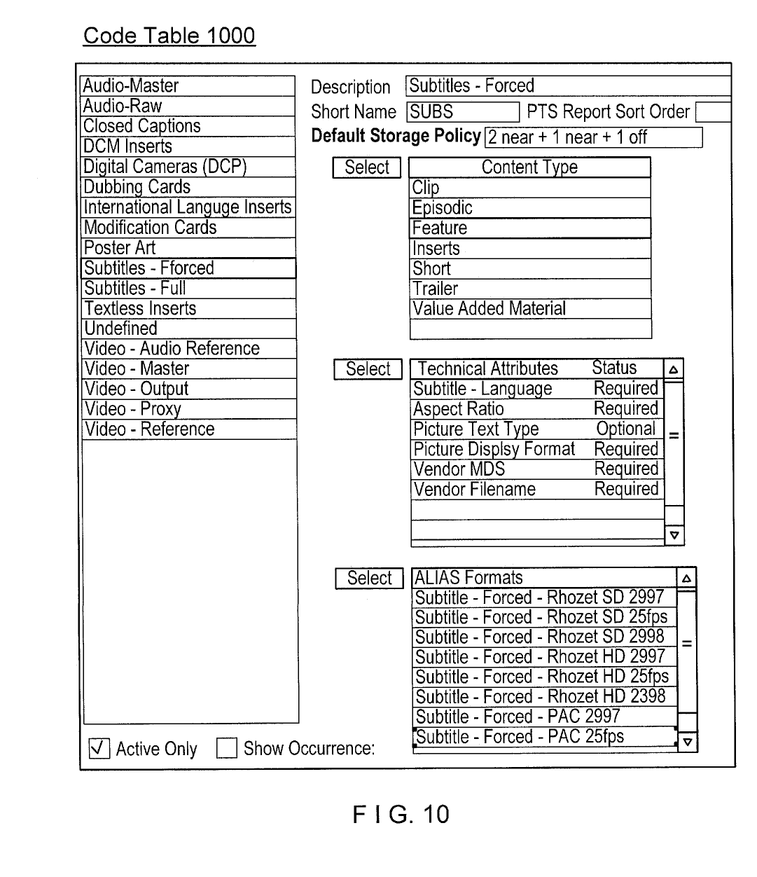

The ingest component 120 may also configure business rules for automation of metadata. For instance, the ingest component 120 may configure which technical attributes are required-by-rendition or optional-by-rendition in a code table of the preservation component 110. An exemplary code table 1000 is depicted in FIG. 10. The ingest component 120 may configure a default storage policy in the code table and configure which formats are valid-by-rendition in the preservation component 110. The ingest component 120 may integrate to a title/version system for the retrieved title metadata and leverage code table content types assignments that are valid-by-rendition in the preservation component 110. Furthermore, the ingest component 120 may configure requirements for frame rate, file extension, height and width rules per-format within a format code table of the preservation component 110.

The ingest component 120 may automate business rules for technical validation. For instance, the ingest component 120 may validate a MD5 checksum match (or other types of checksum or digital fingerprint) prior to ingest, confirm that MD5 does not already exist in the preservation component 110, confirm that the provided MD5 is in proper format, confirm that the product title/version exists in the title system of record, etc. Furthermore, the technical validation may compare media information findings on material with certain format definitions, such as detect frame rate, file extension, display resolution mismatches, etc.

The ingest component 120 may feature an ingest review dashboard to monitor and track ingest requests, assign ownership to an ingest ticket, reference or view a file, filter records (e.g., based on a date range, title, source system, user, etc.), edit metadata, track change histories, display and change metadata review status (e.g., “new,” “approved,” “rejected,” “canceled,” etc.), etc. Furthermore, the review dashboard may allow the user to select which ingest location is to be used to determine if a file exists prior to allowing the submission of an ingest workflow. The user may then play the file from the ingest location and submit the ingest workflow to the preservation component 110 once the metadata review is approved. The review dashboard may also prevent any further editing of metadata once the ingest workflow has been submitted.

The ingest component 120 may also utilize ingest automation. This automation may include the ability to reject ingest if MD5 already exists in the preservation component 110, to assign an ingest workflow template ID, to assign default storage policy ID at ingest, to move files to an ingested folder upon successful ingest. The ingest component 120 may also automatically display ingest workflow status (e.g., in progress, successful, quarantined, duplicate, deleted, etc.), display and reference associated barcode information upon ingest, navigate to an asset from the dashboard upon ingest, display and reference associated ingest work orders upon ingest, etc.

The storage policy component 130 may establish and maintain the storage policies and disaster recovery conditions. The tolerance for asset loss is zero for preservation and master assets (e.g., original) because these are expensive, or may even be impossible, to recreate. Accordingly, distribution and proxy assets may be recreated that do not have the same zero tolerance level. The content integrity of assets may be maintained through scheduled health checks to confirm that no corruption exists or repair is made when required. For instance, any corruption found through a failed health check may be repaired within a predetermined time period (e.g., within one week).

Examples of functional specifications for the storage policy component 130 may provide that at least two copies of all assets are system accessible and are to be registered in a digital asset management system. In addition, all copies of assets may be migrated to any new media, based on technology obsolesce and supportability. Checksums or other digital fingerprints on all copies may be generated and validated on a periodic basis. Additional policies may include conditions for asset replication, media migration, geographical separation, asset access, etc. For example, the copies may be stored in geographically diverse locations and may also be stored in technically diverse storage media to protect against geographic location failure (e.g., flood, power failure, physical destruction, etc.) and storage media failure (e.g., media deterioration, material flaws, etc.) It should be noted that the exemplary embodiments described the use of checksums to monitor the health of the assets. However, any other method of monitoring the health of the assets may be used (e.g., digital certificates, digital signatures, etc.).

The health check and repair component 140 may establish and maintain the health check policies and conditions. According to the exemplary embodiments, the health check and repair component 140 may automatically run health checks on assets based on a predetermined schedule. If the health check fails an error notification may be sent to an achieve team. The repair process may be triggered automatically following the failed health check, and policies may dictate the time frame for performing the repair operations (ex: within 72 hours). Upon a successful repair, the health check component 140 may re-execute a health check on the assets. Furthermore, information related to the health check and the repair operations may be logged in a historical transaction log maintained for each record.

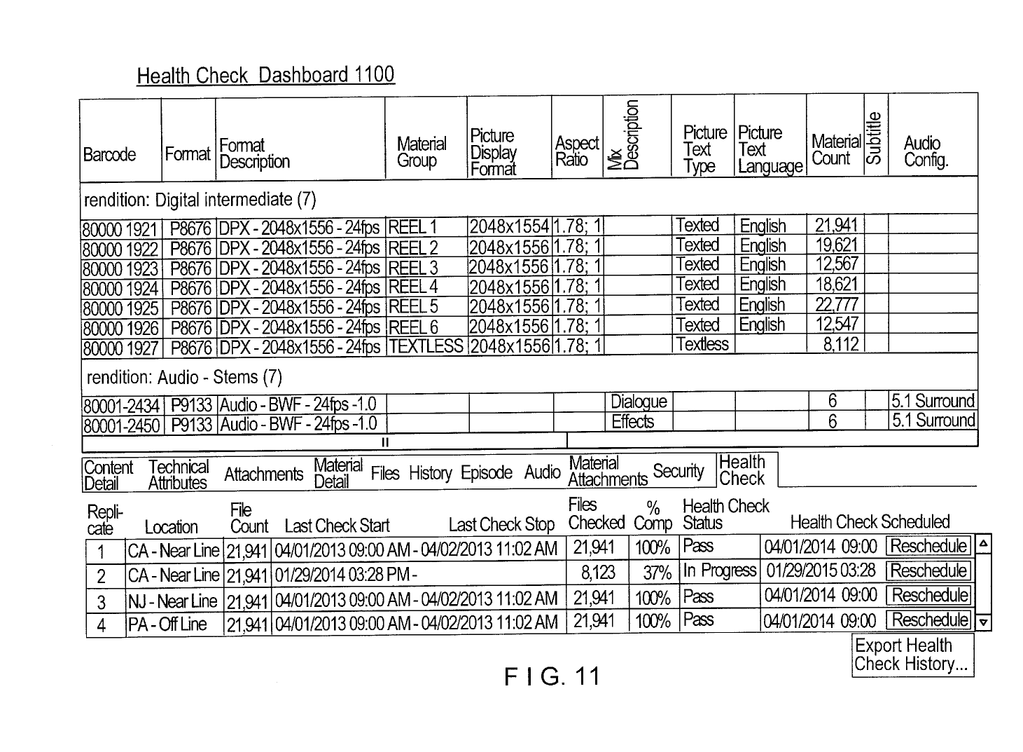

The health check and repair component 140 may feature a health check dashboard to monitor and track any health checks. An exemplary health check dashboard 1100 is depicted in FIG. 11. In addition, the user may review a replicate summary of health check status, update schedule dates for subsequent health checks, export health check per-replicate history information, etc.

The searching component 160 may establish and maintain the search conditions for the preservation component 110. The search conditions may include searchable fields, wherein the fields introduced with complex assets and health checks may be searchable in a material search dashboard to the user. Attributes may include material attributes (e.g., group type, etc.), file attributes (e.g., file name, MD5 checksum, ingest date, file status, etc.), health check attributes (e.g., last check date, next check date, health check status, replicate location, etc.), etc.

Furthermore, the fields introduced with complex assets and health checks may be available selections in a comprehensive search result grid. The result set may continue to be populated with material rows that match the specific criteria. The results may include static fields (e.g., last health check data, next health check date, group type, etc.) as well as aggregated fields (e.g., total file count, total file size, health check file count, health check progress, health check status, etc.).

The reporting component 150 may establish and maintain reporting policies for the preservation component 110. For instance, the reporting policies may relate to asset inventory reporting, asset movement reporting, asset health reporting, etc.

The export component 170 may control the exporting of the asset to users of the preservation system 100. For example, the preservation system 100 may receive a request for an asset export from a user via the user interface 180. The export component 170 may determine if the requesting user has permission to export the requested asset and then fulfill or deny the user's request. If the user's request is to be fulfilled, the export component 170 may retrieve the asset via the storage interface 135 and provide the requested asset to the user.

The user interface 180 may include any user interface component such as the exemplary dashboards described above that allows users of the preservation system 100 to interact with the preservation system 100. Other examples may include any type of graphical user interface (GUI) such as an ingest GUI that allows a user to select assets for ingest, a search GUI that allows users to format a search for assets, an export GUI that allows users to select assets for export, etc.

The storage interface component 135 performs multiple functionalities related to the storing of one or more copies of the asset in accordance with the storage policies that are set for the asset in the storage policy component 130. The storage interface component may facilitate the movement of complex/single assets to a hierarchical storage management (“HSM”) ownership. This assumes that the storage system will be an HSM type storage facility, but those skilled in the art will understand that any type of storage facility may be used to store the assets. The functionality of the storage interface component 135 is to assure that the ingested assets may be moved from the preservation system 100 to the appropriate storage facility.

The storage interface 135 may also apply the appropriate storage policies for the asset as included in the storage policy component 130. For example, the storage interface component 135 may create one or more asset copies across storage resources/tiers/locations to satisfy the storage policies for the asset.

The storage interface component 135 may also function to amend assets. For example, one or more files may be added to an existing complex asset. In another example, one or more files may be replaced in an existing complex asset. It should be noted that this amendment functionality may not be related to a health check or repair of an asset driven by a health check. To provide a specific example, it may be that the audio track of a complex asset is rerecorded or additional audio is added to the asset. This rerecorded audio track may be used to replace the currently stored audio track or the additional audio track may be added to the asset.

The storage interface component 135 may also be used to control deaccession for assets. Deaccession refers to situations where an organization has lost rights or any reason the organization would like to permanently prevent future access to a given asset. The deaccession may be a full deaccession that prevents access to all files included in a complex asset or a partial deaccession that prevents access to one or more files in a complex asset.

The storage interface component 135 may also be used to access assets for export. As described above, the export component 170 may control access to the assets for the purposes of exporting the assets. However, the storage interface component 135 may retrieve the asset from the storage facility (e.g., HSM facility) and make the asset available for a media asset management (“MAM”) component to which the asset is exported. This exporting may be a full export that copies all files included in a complex asset to a MAM accessible storage tier or a partial export that copies one or more files included in a complex asset to MAM accessible storage.

The storage interface component 135 may also implement the functionality to perform the health checks as defined in the health check and repair component 140. A full health check may read all files included in a complex asset to a MAM accessible storage for checksum verification. A partial health check may read one or more files included in a complex asset to a MAM accessible storage for checksum verification.

The storage interface component 135 may also implement the repair functionality as defined in the health check and repair component 140. For example, upon detection of an unwanted file change during the health check, the storage interface component 135 may implement a full repair that creates a new complex asset copy from an existing good copy on new storage media. In another example, upon detection of an unwanted file change during the health check, the storage interface component 135 may implement a partial repair that creates a new complex asset copy from an existing good copy on new storage media. In a further example, upon detection of an unwanted file change and where no good copies reside on the storage facility media, the storage interface component may begin the repair process from an externally sourced asset with the same checksums.

The storage interface component 135 may also support migration of assets. This migration may include a full migration that moves all files included in a complex asset to a new storage entity. Migration could also include moving to a newer generation data tape such as LTO-5 to LTO-7 or to a new storage platform. The storage interface component may also provide linear tape access to files and multiple threads and control over the sequence of file on linear tape storage resource.

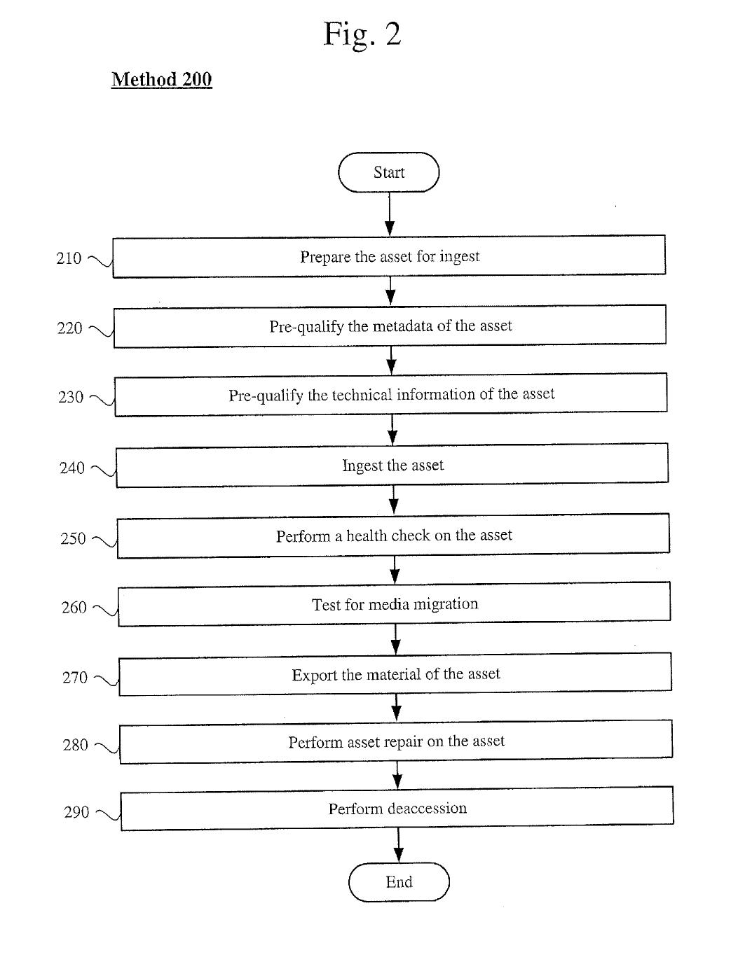

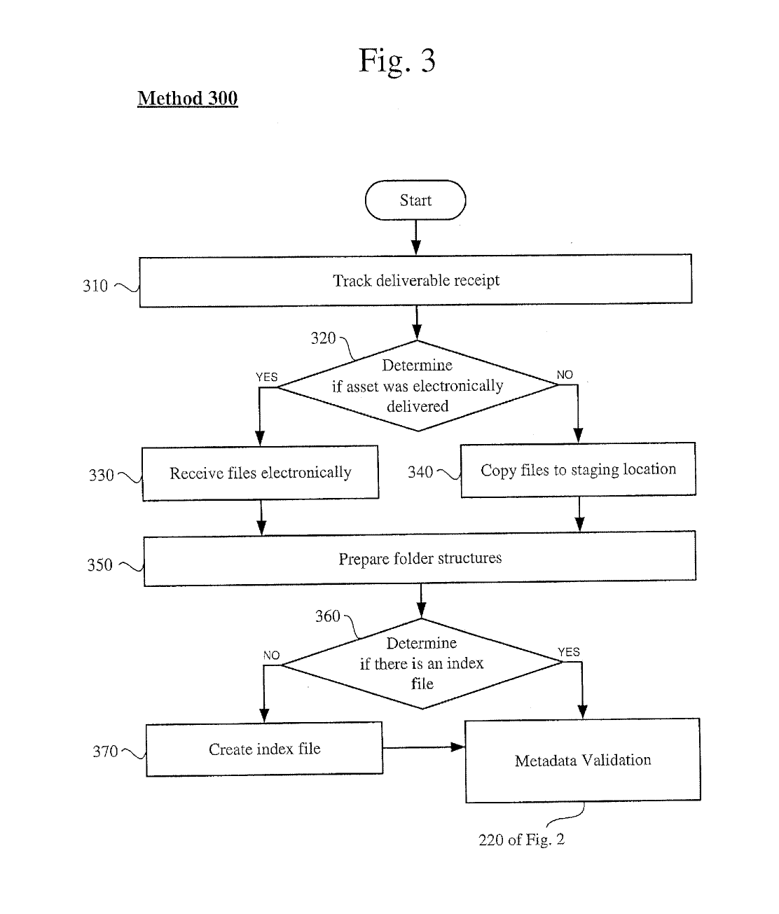

FIG. 2 shows an exemplary method 200 for asset preservation and digital archiving according to the exemplary embodiments described herein. The steps performed by the method 200 will be described in reference to the exemplary preservation system 100 and its components as shown in FIG. 1. Furthermore, each of these steps will be described in greater detail in FIGS. 3-9.

In step 210, the processor 110 may prepare the asset for ingest. The asset preparation may be performed at the ingest component 120 of the preservation system 100 in FIG. 1. FIG. 3 shows an exemplary method 300 for preparing an asset for ingest according to the exemplary embodiments described herein.

In step 310, the method 300 may track a deliverable receipt of the asset. Deliverable tracking is a process of ensuring the preservation system receives specific assets. At step 320, a determination may be made as to whether the asset was delivered electronically. If the asset was delivered electronically, in step 330 the ingest request component 120 may receive the files electronically and the method 300 may advance to step 350. If the asset was not received electronically, in step 340 the files may be copied to a staging location of the preservation component 110 and the method 300 may advance to step 350.

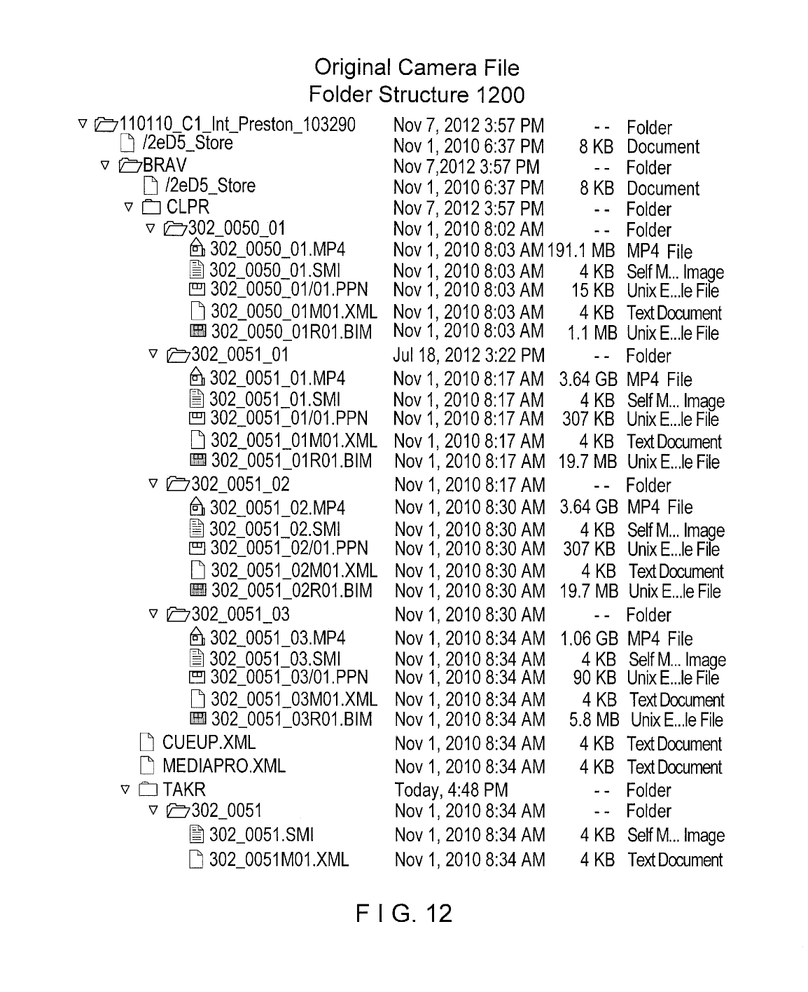

In step 350, the method 300 may prepare folder structures for the asset information. As described above, each complex asset may include many different files and types of files. A folder structure may be used to store these files/files types. In step 350, the asset is analyzed and based on the files and file types, a folder structure is created to efficiently store the files. FIG. 12 shows an example folder structure 1200 for an original camera file. Other files may have different folder structures.

In step 360, a determination may be made as to whether the asset information includes an index file. Examples of an index file were described above. If the asset information does not include an index file, in step 370 an index file may be created and the method 300 may advance to step 380 for metadata validation. If the asset information include an index file, the method 300 may advance to metadata validation (step 220).

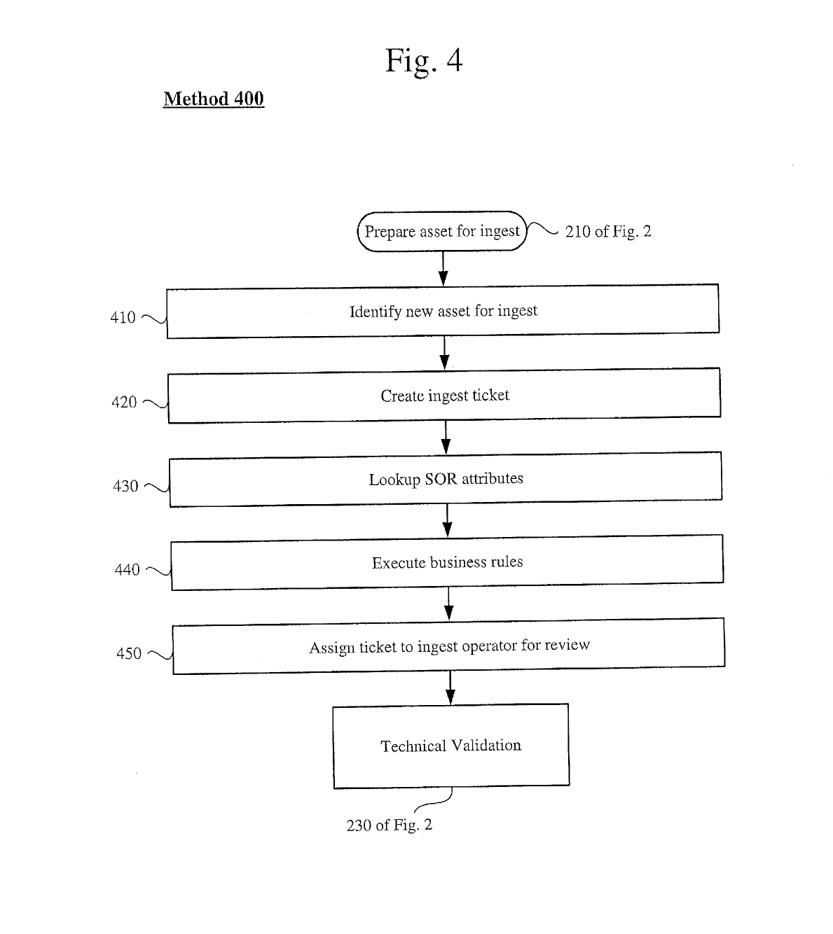

Returning to FIG. 2, in step 220 the processor 115 may pre-qualify the metadata information of the asset. The metadata validation may be performed at the ingest component 120 of the preservation system 100 in FIG. 1. FIG. 4 shows an exemplary method 400 for metadata validation according to the exemplary embodiments described herein.

In step 410, the method 400 may identify a new asset for ingest and determine whether the new asset is a single-part asset or a complex multi-part asset. In step 420, the method 400 may create an ingest ticket, wherein single material metadata is entered for a single-part asset or multiple material metadata is entered for a complex asset. In step 430, the method 400 may look up a system of record (“SOR”) attribute(s) of the asset. Examples of SOR attributes may include, Title, Version, Product Codes, Release Date, Runtime, Director, etc. If the SOR attributes are not permissible, a ingest ticket status may updated indicating the problem with the asset.

In step 440, the method 400 may execute business rules. As noted above, an example of the business rules may be to dictate which attributes of the asset are required-by-rendition or optional-by-rendition based on a rendition code table. Those skilled in the art will understand that any type of business rules may be executed in step 440 depending on the type of metadata that is being validated. If the business rules are not executable, a ingest ticket status may updated to indicate the problem with the asset/metadata. In step 450, the ingest ticket is assigned for operator review and, subsequently, technical validation (step 230). It should be noted that the entire process may be automated and the operator review may be skipped if all validation checks are satisfied. However, the inclusion of the operator review allows certain security checks to be performed as described in the examples provided above. This applies to all steps that indicate operator review.

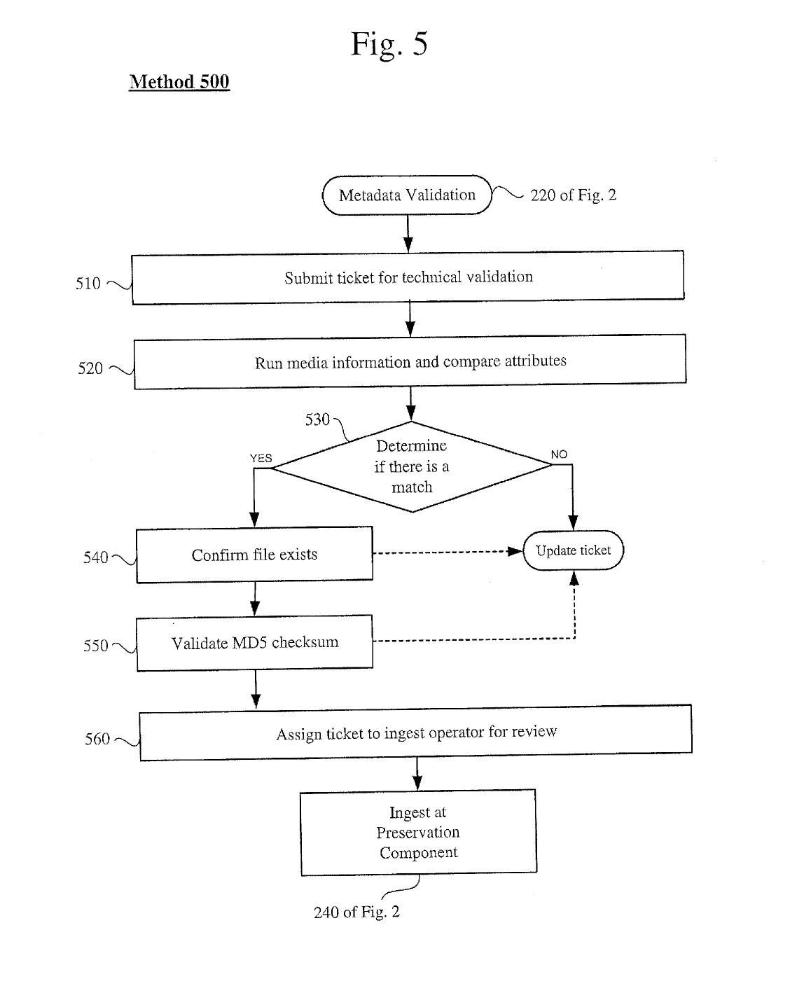

Returning to FIG. 2, in step 230 the processor 115 may pre-qualify the technical information of the asset. The technical validation may be performed at the ingest component 120 of the preservation system 100 in FIG. 1. FIG. 5 shows an exemplary method 500 for technical validation according to the exemplary embodiments described herein.

In step 510, the method 500 receives the submitted ticket for technical validation. In step 520, the method 500 runs the media information and compares attributes. If there is no match, the ingest ticket status may be updated. If there is a match, the method 500 confirms that the match file exists in step 530. If the confirmation fails, the ingest ticket status may be updated. If the match is confirmed, the method 500 validates the MD5 checksum in step 540. If the MD5 checksum is invalid, the ingest ticket status may be updated. If the MD5 checksum is validated, in step 550, the ingest ticket is assigned for operator review (step 560) and, subsequently, ingest (step 240).

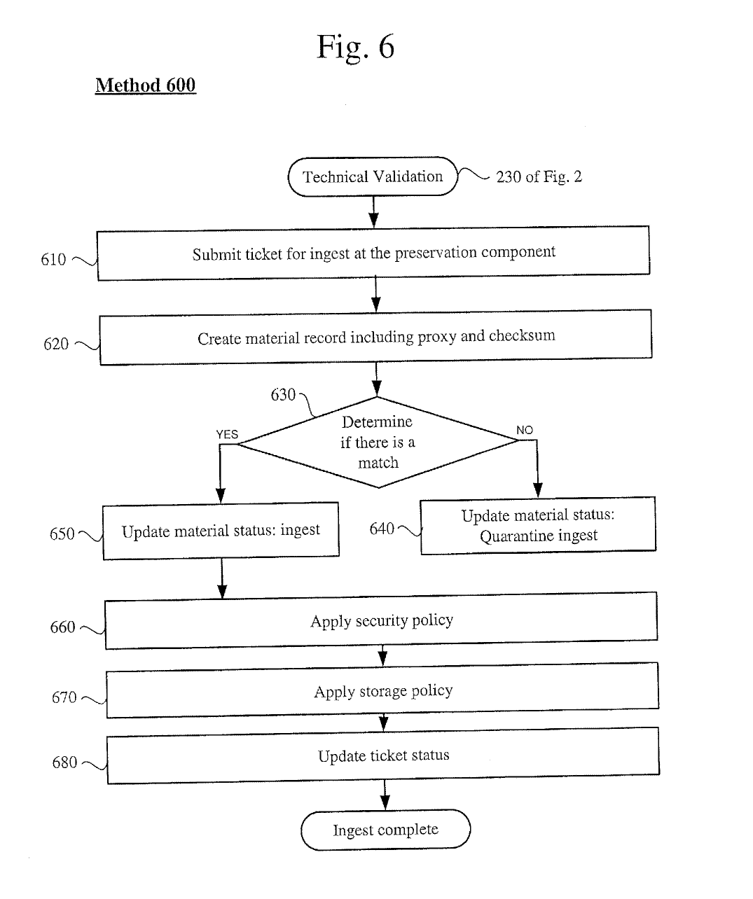

Returning to FIG. 2, in step 240 the processor 115 may ingest the asset. The ingest may be performed at the ingest component 120 of the preservation system 100 in FIG. 1. FIG. 6 shows an exemplary method 600 for ingest by the preservation component according to the exemplary embodiments described herein.

In step 610, the method 600 receives the submitted ticket for ingest. In step 620, the method 600 creates a material record for the asset, wherein the material record may generate one or more proxy assets and archive and generate a checksum. In step 630, the method 600 confirms that the checksum provided in the ingest ticket matches the delivered digital file checksum. If the checksums do not match, the ingest is quarantined step (640). If the checksums do match, the ingest proceeds (step 650). In step 660, the method 600 may apply the security policies of the preservation component 110. In step 670, the method 600 may apply the storage policies established and maintained in the storage/recovery component 130 (e.g., number of copies, geographic diversity, storage media diversity, etc.). In step 680, the ingest ticket status is updated and ingest is complete.

Thus, at the completion of step 240, the ingest is complete and the preservation system is now in custody of the asset (e.g., the asset is stored in multiple locations according to the storage policies). The remainder of the method 200 is directed to those actions that are used to maintain the asset (e.g., apply ongoing preservation principles per the storage policy) and retrieve the asset for further use.

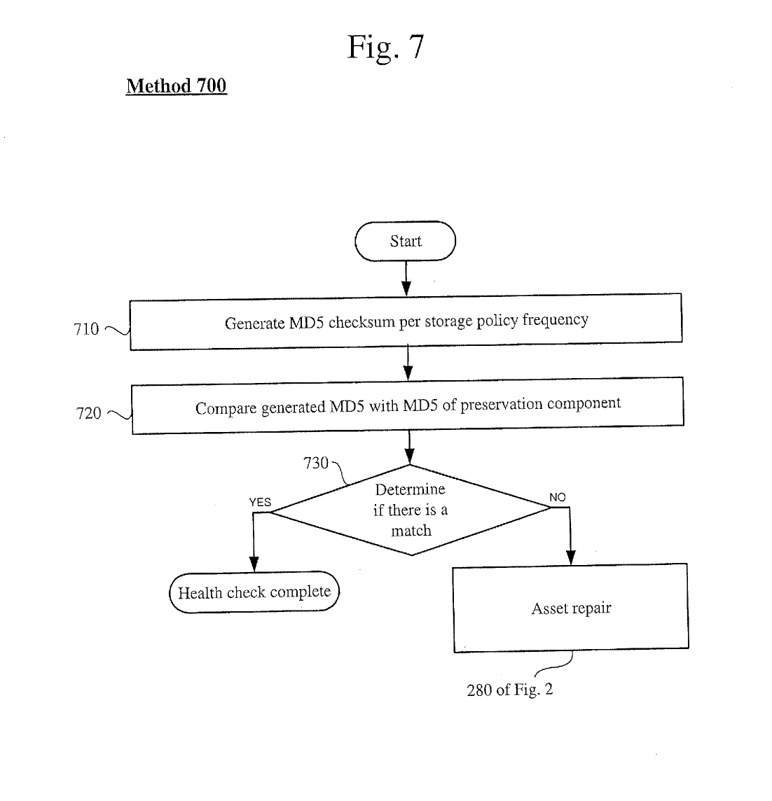

Returning to FIG. 2, in step 250 the processor 115 may perform a health check on the asset. The health check may be performed at the health check and repair component 140 of the preservation system 100 in FIG. 1. The health checks are systematic and repeatable calculations used to validate the digital fingerprint of a file. Any differences in the calculated value over time are a reliable indicator of an unwanted file change such as corruption. FIG. 7 shows an exemplary method 700 for performing a health check on a material according to the exemplary embodiments described herein.

In step 710, the method 700 may generate an MD5 checksum per storage policy frequency (e.g., a predetermined periodic basis). In one example, the frequency may be yearly. However, those skilled in the art will understand that other frequencies may be used and the frequencies may vary among different asset classes. In step 720, the method 700 may compare the generated MD5 checksum of the asset (this may include all stored copies of the asset) to the MD5 checksum of the preservation component 110. If there is no match determined in step 730, the asset may be deemed corrupt and be sent for asset repair (step 280). If there is a match determined in step 730, the health check process is complete and the asset copy is determined to be healthy. All health check activity and repair actions are recorded in a historical transaction log maintained for each replicate of each file.

Returning to FIG. 2, in step 260 the processor 115 may test for media migration. Media migration refers to either an automated process for moving assets to different media based on the media age and tape cycle rules or a manual process such as when procuring/capitalizing new storage infrastructure. Assets may be periodically migrated to new storage media considered reliable and supportable by Information Technology (IT) services. While this function is not required to reside in the preservation system, since the function is generally related to asset preservation, the preservation system is a natural location for the function. To provide a specific example, a full migration may involve moving all files included in a complex asset to a new storage entity. For example, migration could include moving to a newer generation data tape such as LTO-5 to LTO-7 or to a new storage platform.

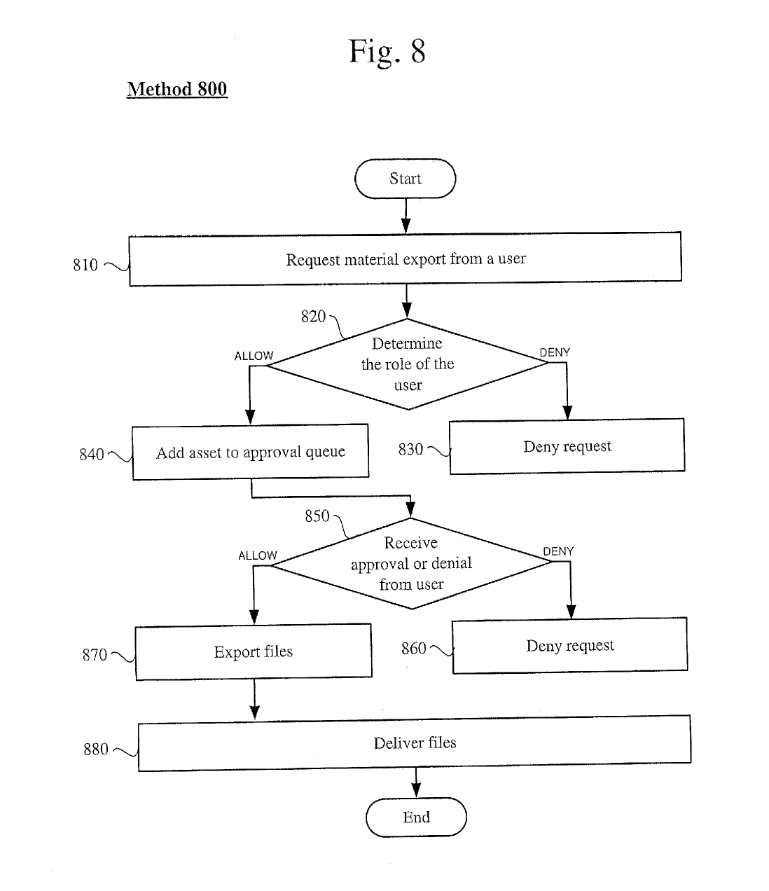

Returning to FIG. 2, in step 270 the processor 115 may export the material. The material exportation may be performed at the export component 170 of the preservation system 100 in FIG. 1. FIG. 8 shows an exemplary method 800 for exporting material according to the exemplary embodiments described herein.

In step 810, the method 800 may receive a request for material export from a user. In step 820, a determination may be made based on the assigned application permission role of the user. If the user's role does not allow for access, the method 800 may advance to 830 wherein the request for material export is denied. If the user's role allow for access, the method 800 may advance to 840 wherein the asset is added to an approval queue.

In step 850, the method 800 may receive either an approval or a denial of the export from the user. If the user denies the request, the method 800 advances to 860 and denies the export request. If the user approves the request, the method copies the files (step 870) to the location specified in the request (step 880).

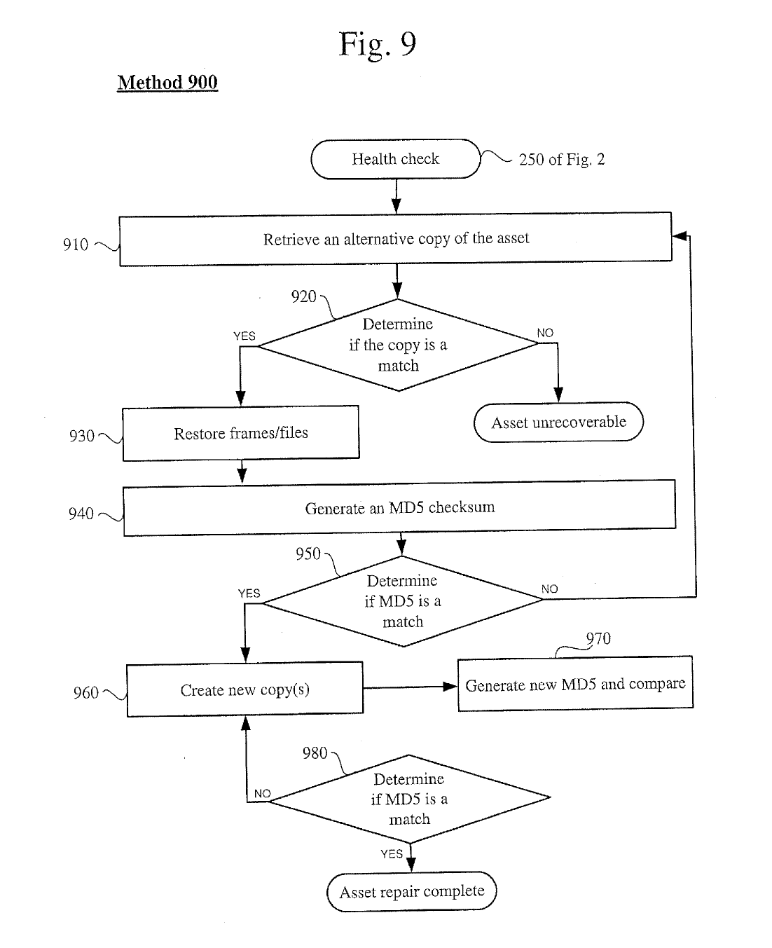

Returning to FIG. 2, in step 280 the processor 115 may perform asset repair on any corrupted assets. The repair may be performed at the health check and repair component 140 of the preservation system 100 in FIG. 1. FIG. 9 shows an exemplary method 900 for repairing an asset according to the exemplary embodiments described herein.

Upon receiving the identity of the corrupted asset from the health check and repair component 140, the method 900 may determine in step 910 if an alternative copy of the asset is available. As described extensively above, the storage policies for the asset will provide for multiple storage copies of the asset. In step 920, the method 900 may determine if the alternative copy is a match. If it is a match, the method 900 may advance to a recovery process, including the restoration of frames and files (step 930), the generation of an MD5 checksum (step 940), and the comparison of this MD5 checksum with the MD5 from the preservation component 110 (step 950). If it is not a match, the method 900 may return to step 910 to determine if a further alternative copy is available. If it is a match, the method 900 may advance to step 960. If no matches are found, the asset may be deemed unrecoverable. However, it should be noted that the method iterates through all the available alternative copies before making a determination that the asset is unrecoverable.

The method 900 then creates a new copy of the asset (step 960) and generates a further MD5 checksum for comparison (970). In step 980, the method 900 matches the newly created MD5 checksum of the copy against the MD5 checksum from the preservation component 110. If it is not a match, the method 900 may return to step 960 to create a further new copy of the asset. If is it is a match, then the asset repair process is complete. It should be noted that the repair method may create as many new copies as necessary to satisfy the storage policy for the asset. For example, if it is determined that two of three copies are found to be a mis-match, two new copies would be made.

Returning to FIG. 2, in step 290 the processor 115 may perform deaccession. Deaccession may occur when an asset is no longer relevant (e.g., replaced), if an organization has lost rights or any reason the organization would like to permanently prevent future access to a given asset. Those skilled in the art will understand that some assets may never be deaccessed.

Those of skill in the art will understand that the above-described exemplary embodiments may be implemented in any number of matters, including hardware components, software components or any combination thereof. For example, the exemplary preservation system 100 of FIG. 1 may include a non-transitory computer readable storage medium with an executable program stored thereon, wherein the program instructs the processor 115 to perform actions related to method 200 of FIG. 2. Furthermore, it will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
preparing a digital file for ingest into an asset management system;
storing a plurality of copies of the digital file based on a set of storage policies for the digital file;
performing a health check on each copy of the digital file; and
performing an asset repair on each copy of the digital file that failed the health check.

2. The method of claim 1, wherein the storage policies include storing at least two of the plurality of copies of the digital file in one of geographical diverse locations and diverse storage media.

3. The method of claim 1, further comprising:
exporting one of the plurality of copies of the digital file, wherein the exporting is controlled based on a user identification, the exporting including formatting the one of the copies for a platform to which the one of the copies is to be exported.

4. The method of claim 1, wherein the digital file is one of a single asset and a complex asset.

5. The method of claim 1, wherein the health check is based on a reliable digital fingerprint for each copy of the digital file.

6. The method of claim 1, wherein the health check is performed at predetermined intervals for each copy of the digital file.

7. The method of claim 1, further comprising:
logging the performance of the health check on each copy; and
logging asset repairs on each copy.

8. The method of claim 1, further comprising:
creating the plurality of copies of the digital file, wherein each copy is in a format that is appropriate for the storage policies for the corresponding copy.

9. The method of claim 1, further comprising:
restricting access to at least some of the plurality of copies.

10. The method of claim 1, wherein the asset repair comprises:
replacing each copy of the digital file that failed the health check with another one of the copies of the digital file that did not fail the health check.

11. A system, comprising:
a processor; and
a non-transitory computer readable storage medium including a set of instructions that when executed by the processor, cause the processor to perform operations, comprising,
preparing a digital file for ingest into an asset management system;
storing a plurality of copies of the digital file based on a set of storage policies for the digital file,
performing a health check on each copy of the digital file, and
performing an asset repair on each copy of the digital file that failed the health check.

12. The system of claim 11, wherein the storage policies include storing at least two of the plurality of copies of the digital file in one of geographical diverse locations and diverse storage media.

13. The system of claim 11, wherein the operations further comprise:
exporting one of the plurality of copies of the digital file, wherein the exporting is controlled based on a user identification, the exporting including formatting the one of the copies for a platform to which the one of the copies is to be exported.

14. The system of claim 11, wherein the health check is based on a reliable digital fingerprint for each copy of the digital file.

15. The system of claim 11, wherein the operations further comprise:
logging the performance of the health check on each copy; and
logging asset repairs on each copy.

16. The system of claim 11, wherein the operations further comprise:
creating the plurality of copies of the digital file, wherein each copy is in a format that is appropriate for the storage policies for the corresponding copy.

17. The system of claim 11, wherein the operations further comprise:
receiving metadata for the digital file, wherein the metadata is used to prepare the digital file for ingest.

18. The system of claim 11, wherein the storing of the plurality of copies include storing the copies in a hierarchical storage management system.

19. A system, comprising:
an ingest component, implemented by a processor, to prepare a digital file for ingest into an asset management system;
a storage policy component, implemented by the processor, to indicate a storage policy for the digital file;
a storage interface, implemented by the processor, to store a plurality of copies of the digital file based on the storage policy for the digital file;
a health and repair component, implemented by the processor, to perform a health check on each copy and perform an asset repair on each copy that failed the health check.

20. The system of claim 19, further comprising:
an export component, implemented by the processor, to export one of the plurality of copies of the digital file, wherein the exporting is controlled based on a user identification, the exporting including formatting the one of the copies for a platform to which the one of the copies is to be exported.
